(19) United States
(12) Patent Application Publication
(10) Pub. No.: US 2013/0243677 A1
(43) Pub. Date: Sep. 19, 2013

(54) AMINE TREATING PROCESS FOR SELECTIVE ACID GAS SEPARATION

(71) Applicants: Michael SISKIN, Westfield, NJ (US); Robert Basil FEDICH, Long Valley, NJ (US); Pavel Kortunov, Flemington, NJ (US); Hans THOMANN, Bedminister, NJ (US)

(72) Inventors: Michael SISKIN, Westfield, NJ (US); Robert Basil FEDICH, Long Valley, NJ (US); Pavel Kortunov, Flemington, NJ (US); Hans THOMANN, Bedminister, NJ (US)

(73) Assignee: ExxonMobil Research and Engineering Company, Annandale, NJ (US)

(21) Appl. No.: 13/793,410

(22) Filed: Mar. 11, 2013

Related U.S. Application Data
(60) Provisional application No. 61/610,727, filed on Mar. 14, 2012.

(51) Int. Cl. C09K 3/00; B01D 53/14

(52) U.S. Cl. CPC C09K 3/00; B01D 53/1468
USPC 423/228

(57) ABSTRACT

A process for the selective separation of hydrogen sulfide from gas mixtures containing carbon dioxide as well as other acidic gases uses severely sterically hindered amino alcohol absorbents based on amino alcohols and ethers containing secondary nitrogen atoms hindered by an alpha tertiary carbon atom. Preferred absorbents include 2-(N-methylamino)-2-methylpropan-1-ol, (2-(N-ethylamino))-2-methylpropan-1-ol, (2-(N-isopropylamino)-2-methylpropan-1-ol, SBAE (2-(N-sec-butylamino)-2-methylpropan-1-ol) and (2-(N-t-butylamino)-2-methylpropan-1-ol.

### CROSS REFERENCE TO RELATED APPLICATIONS

This application is related to and claims priority benefit from U.S. Application Ser. No. 61/610,727, filed 14 Mar. 2012.

### FIELD OF THE INVENTION

The present invention relates to the absorption of acidic gases from mixed gas streams containing acidic and non-acidic components.

### BACKGROUND OF THE INVENTION

The treatment of gases and liquids containing acidic gases such as CO₂, H₂S, CS₂, HCN, COS and sulfur derivatives of C₁ to C₄ hydrocarbons with amine solutions to remove these acidic gases as well established and finds utility in commercial processes such as ExxonMobil's FLEXSORB™ process and Shell's SCOT™ process. These and other treatment processes have been used widely in Acid Gas Enrichment, Tail Gas Clean-Up and other processes particularly where selective and reversible separation of hydrogen sulfide from gas mixtures containing other acidic components is required. The amine absorbent typically contacts the acidic gases or the liquids in the form of an aqueous solution containing the amine in an absorber tower with the aqueous amine solution passing in countercurrent to the acidic fluid. Common amine sorbents include monoethanolamine (MEA), diethanolamine (DEA), methyldiethanolamine (MDEA), diisopropylamine (DIPA), or hydroxyethoxyethylamine (DGA). The liquid amine stream contained the sorbed acid gas is typically regenerated by desorption of the sorbed gases in a separate tower with the regenerated amine and the desorbed gases leaving the tower as separate streams. The various gas purification processes which are available are described, for example, in Gas Purification, Fifth Ed., Kohl and Neilsen, Gulf Publishing Company, 1997, ISBN-13: 978-0-88415-220-0.

Although primary and secondary amines such as MEA, DEA, DPA, and DGA absorb both H₂S and CO₂ gas, they have not proven especially satisfactory for selective absorption of H₂S to the exclusion of CO₂ because in aqueous solution, these amines undergo more selective reaction with the more acidic CO₂ to form carbamates. The tertiary amine, MDEA, has been reported to have a high degree of selectivity toward H₂S absorption over CO₂ (Frazier and Kohl, Ind. and Eng. Chem., 42, 2288 (1950)), but its commercial utility is limited because of its restricted capacity for H₂S loading and its limited ability to reduce the CO₂ content of the gas. Similarly, diisopropylamine (DIPA) is relatively unique among secondary amino alcohols in that it has been reported to have been used industrially, alone or with a physical solvent such as sulfolane, for selective removal of H₂S from gases containing H₂S and CO₂.

The occurrence of a chemical reaction in the absorbent solution has the effect of increasing the liquid phase absorption coefficient over that which would be observed with simple physical absorption in comparison with diffusion phenomena. [Savage, D. W.; Astarita, J.; Joshi, S. Chem. Eng. Sci, 1980, 35, 1513.]

H₂S+OH⁻═HS⁻+H₂O

Since hydrogen sulfide is absorbed more rapidly than carbon dioxide by aqueous alkaline solutions, partial selectivity can be attained when both gases are present. The data of Garner et al. [Garner, F. H.; Long, R.; Pennell, A. J. Appl. Chem. 1958, 325-336.] indicate that selectivity is favored by short gas-liquid contact times and low temperatures. Commercial applications of selective absorption based on short residence time contact are described by Hohlfield [Hohlfield, R. W. Oil Gas J. 1979, 129.] and Kent and Abid. [Kent, V. A.; Abid, R. A. Proc. Gas Conditioning Conf. Univ. of OK, 1985.]

Sterically hindered amines react faster with H₂S than with CO₂ via a proton transfer mechanism. A number of severely sterically hindered aminoether compounds have been developed for the selective removal of H₂S in the presence of CO₂. U.S. Pat. Nos. 4,405,581; 4,405,583; 4,405,585; 4,471,138 and 4,894,178 disclose these highly effective hindered selective absorbents to which reference is made for a full description of these materials and their use in acidic gas sorption processes. U.S. 2010/0037775 discloses alkylamine alkyloxy alkyl ethers which are selective for the sorption of H₂S from acidic gas mixtures containing CO₂.

### SUMMARY OF THE INVENTION

We have now discovered that hydrogen sulfide can be selectively separated from carbon dioxide in acidic gas mixtures which may also contain other acidic gases such sulfur dioxide, carbonyl sulfide, carbon disulfide, hydrogen cyanide, and sulfur derivatives of light (C1-C4) hydrocarbons as can be effected using severely sterically hindered amino absorbents which also possess useful characteristics of relatively low molecular weight coupled with acceptable boiling point (relative to their molecular weight) as well as good thermal and oxidative stability, viscosity and other properties.

The class of severely sterically hindered amine absorbents according to the present invention are characterized by a secondary amino nitrogen atom linked to an adjacent (alpha) tertiary carbon atom. The preferred compounds of this type are amino alcohols with one such secondary amino group present in the molecule but amino ethers with two such groups are also useful. The secondary amino compounds of the present invention are alcohols and ethers defined by the formula:

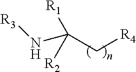

where R₃ is a C₁-C₄ alkyl group, CH₃, R₁ and R₂ are each a C₁-C₄ alkyl group, preferably CH₃ or C₂H₅, R₄ is OH or OR₅ where R₅ is a C₁-C₅ alkyl, or —CH₂—CR₁R₂— NHR₃ and n is an integer from 1 to 4, preferably 1-3. The R₁, R₂, R₃ groups of R₅ may be the same or different to those in the remainder of the molecule and may be branched chain groups such as iso-propyl, iso-butyl, sec-butyl or tert.-butyl to add more steric hindrance to slow down the reaction between the amine and CO₂ still further, with tertiary alkyl groups, especially tert.-butyl being preferred for their high degree of steric hindrance. A high degree of steric hindrance around the amino nitrogen may be conferred by using tertiary alkyl groups, e.g. tert.-butyl, for R₃; one or both of R₁ and R₂ may optionally be tertiary alkyl, e.g. tert.-butyl.

The preferred selective absorbents are the amino alcohols defined by the formula:

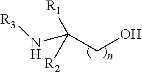

where R₁ is CH₃, R₂ and R₃ are CH₃ or C₂H₅ and n is as defined above.

When R₅ is —CH₂—CR₁R₂—NHR₃, the compounds are symmetrical or asymmetrical; one preferred symmetrical ether is bis-(2-methylamino-2,2-dimethylethyl)ether having the formula:

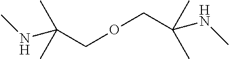

A particularly preferred low molecular weight absorbent is 2-(N-methylamino)-2-methylpropan-1-ol (MAMP) (MW=103 amu) with the formula:

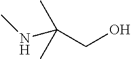

Other preferred absorbents include 2-(N-ethylamino)-2-methylpropan-1-ol, 2-(N-isopropylamino)-2-methylpropan-1-ol), 2-(N-sec-butylamino)-2-methylpropan-1-ol (SBAE) and 2-(N-t-butylamino)-2-methylpropan-1-ol. The present aminoalcohol and aminoether compounds exhibit good selective absorption of hydrogen sulfide in the presence of carbon dioxide under the conditions described below.

### DRAWINGS

In the accompanying drawings:

FIG. 1 is a graph showing ¹³C NMR spectra of 2-methyl-2-(methylamino)propan-1-ol before (top) and after (bottom) chemical reaction with CO₂ at 30° C.;

FIG. 2 is a graph showing ¹³C NMR evolution of CO₂/MAMP reaction products (top) and carbons of MAMP structure (bottom) over time purging CO₂ at 30° C. at 10 sccm;

FIG. 3 is a graph showing CO₂ uptake and solution pH versus time for MAMP at 30° C. (CO₂ flow rate 10 cc/min;

FIG. 4 is a graph showing ¹³C NMR spectra of monoethanolamine (MEA) before (top) and after (bottom) chemical reaction with CO₂ at 30° C.;

FIG. 5 is a graph showing ¹³C NMR spectra of monoethanolamine (MEA) before (top) and after (bottom) chemical reaction with CO₂ at 30° C.

FIG. 6 is a graph showing CO₂ uptake and reaction products versus time for MEA at 30° C. (CO₂ flow rate 10 cc/min)

FIG. 7 is a graph showing the H₂S selectivity of hindered amines for acidic gases.

### DETAILED DESCRIPTION

### General Considerations

When hindered amines are used as an acid gas absorbent, lower molecular weight species are favored because the reaction occurs on a molar basis whereas purchasing and pricing of the material are usually on a weight basis. The lower the molecular weight (atomic mass unit, amu), the lower is the weight percent concentration in the solvent required to remove the same amount of hydrogen sulfide per unit volume of absorbent. The molecular weight of the conventional MDEA absorbent is 119 amu and other selective absorbents may have higher molecular weights; the non-selective MEA has a molecular weight of 61 amu, whereas the preferred selective absorbent of the present invention, MAMP, has a molecular weight of 103 amu, conferring a significant advantage. The amino ethers have higher molecular weights but possessing two amino groups available for reaction with the hydrogen sulfide confer a comparable absorption capacity on a weight for weight basis.

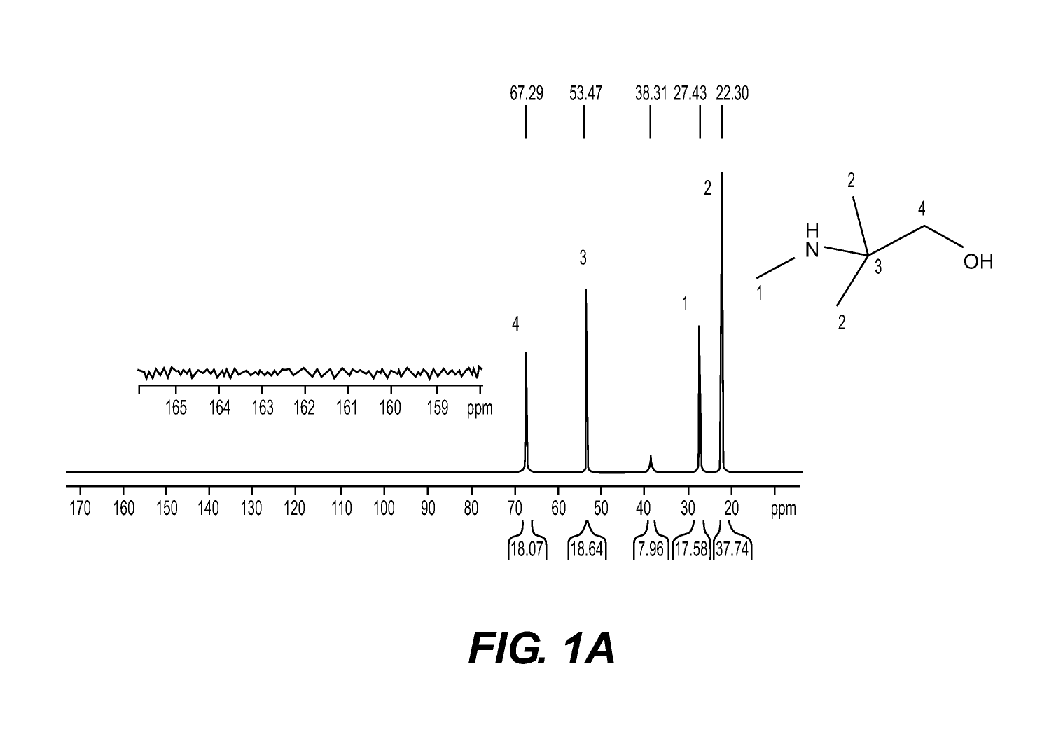

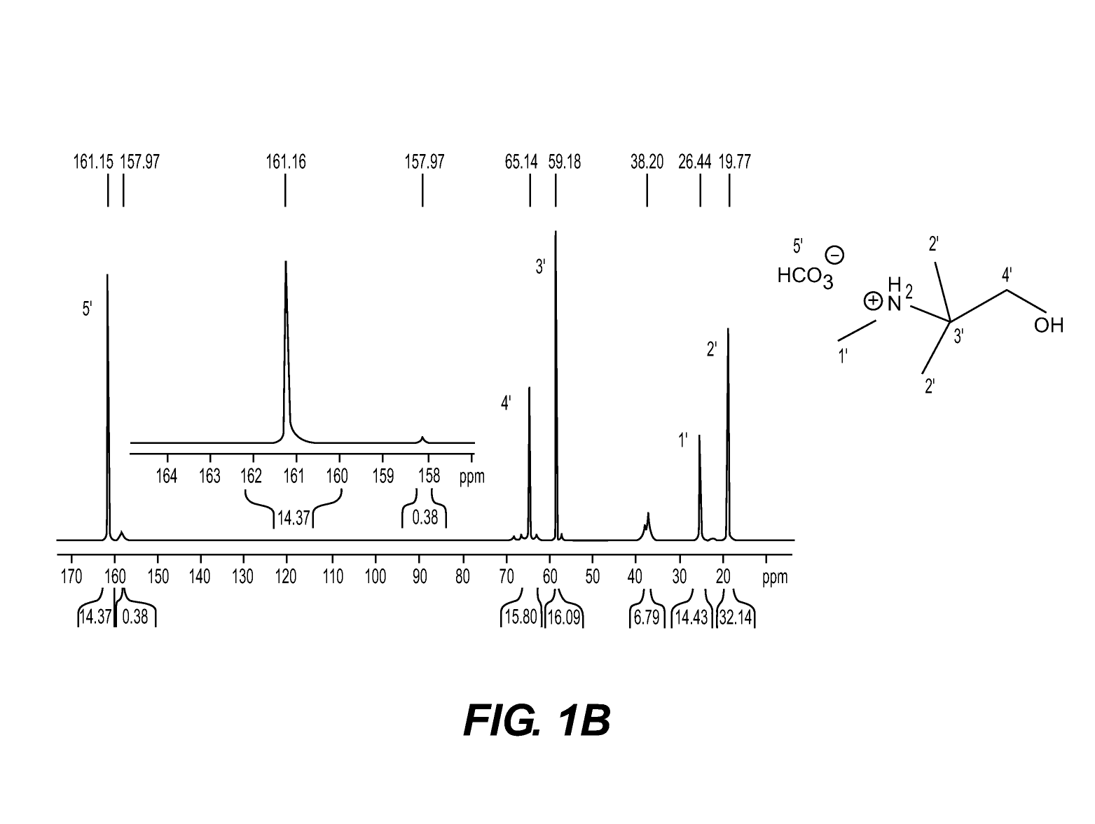

MAMP and its derivatives largely form a carbonate/bicarbonate mixture in aqueous solution with carbon dioxide present in the acid gas mixture. The rate of formation of the bicarbonate is much slower than with 2-amino-2-methylpropanol (AMP) and comparable with tertiary amines such as dimethylaminoethanol (DMAE); the rate of reaction of MAMP with hydrogen sulfide, however, is faster and more selective. Because of steric hindrance, the affinity of the amine nitrogen to attack by hydrogen sulfide is favored, but some of the carbon dioxide directly forms the carbonate/bicarbonate, skipping the carbamate-forming step, with extended reaction times, as represented in FIG. 1. The separation with solvent systems which contain water is therefore optimized by operation under conditions which enable the kinetics to favor the faster H₂S absorption, e.g. by minimizing mass transfer using fewer theoretical trays or by more open packing in the absorber tower.

In organic solvents in the absence of water, e.g., sulfolane, the present sterically hindered alcohol and ether derivatives are unlikely to react with CO₂ to form a stable reaction product, while H₂S which does not require H₂O to react with amines will do so, to favor H₂S even more selectivity further in the presence of dry CO₂. The same consideration applies when the amino compound is used in solid form as described below and in both cases, equilibrium controlled separation becomes feasible.

While the present hindered amines can facilitate rapid kinetically controlled reaction with hydrogen sulfide to achieve selective removal of this component in the presence of water, the residence time during the separation (contact between the acid gas mixture and the absorbent) should be kept short so the hydrogen sulfide absorption product (a mercaptide salt with the hindered amine nitrogen) can be rapidly removed from the absorber to avoid thermodynamic displacement of the initially captured hydrogen sulfide by carbon dioxide with formation of the bicarbonate salt. Because carbon dioxide is a slightly stronger acid in aqueous solution than hydrogen sulfide (its ionization constant for the first step ionization to H⁺ and HCO₃⁻ is approximately 4×10⁻⁷ at 25° C. compared to 1×10⁻⁷ for the corresponding hydrogen sulfide ionization), carbon dioxide can displace previously absorbed hydrogen sulfide under conditions of extended gas-liquid contact where equilibrium is approached. For this reason, short contact times are preferred for better selectivity in the separation of the hydrogen sulfide when working with aqueous solutions of the absorbent.

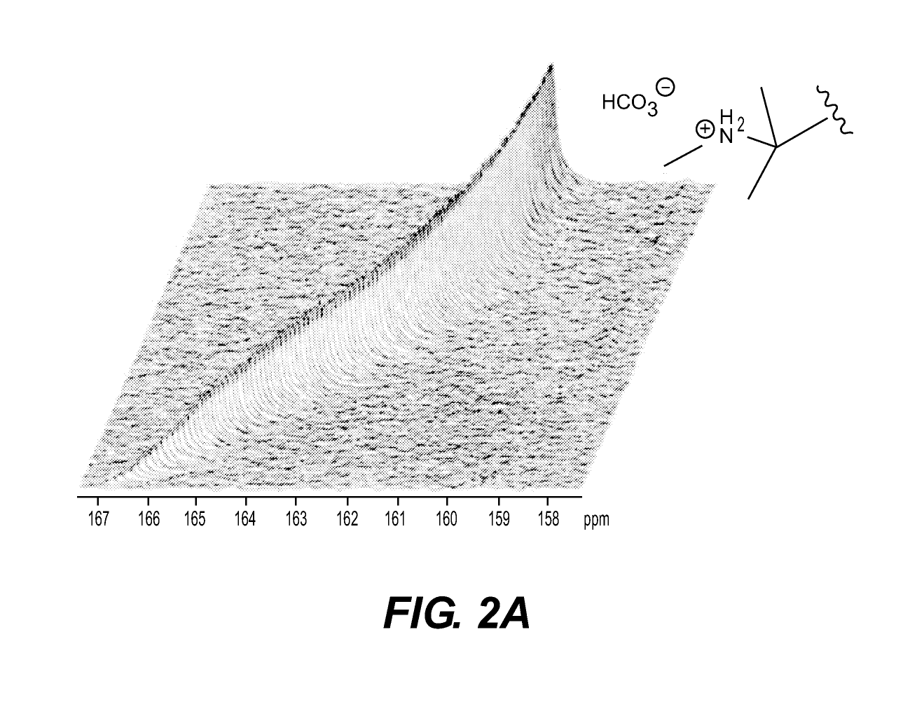

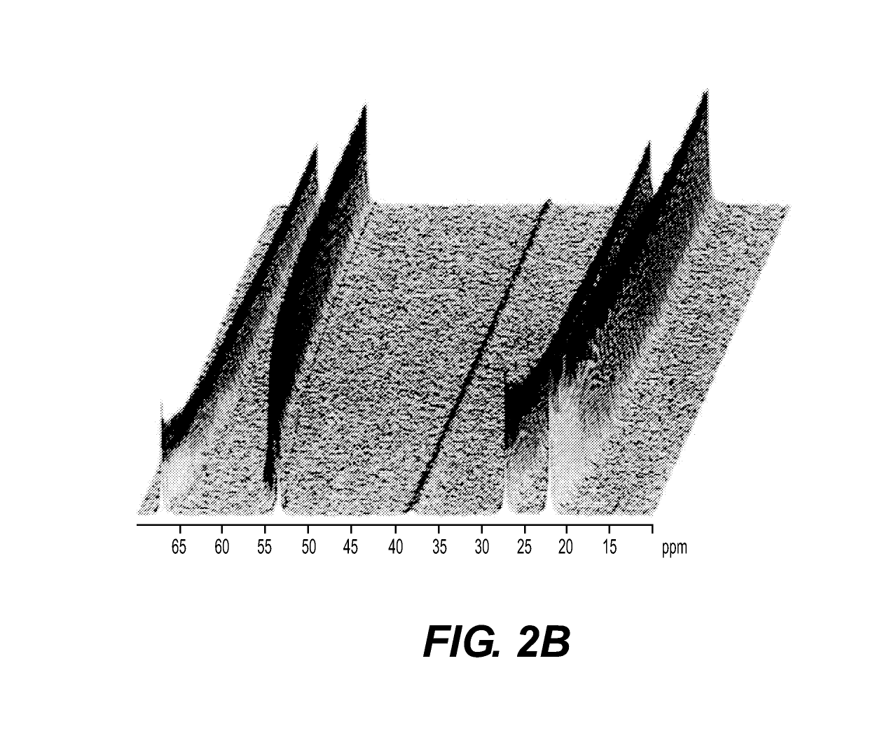

The effect of reaction time with CO₂ concentration under a 100 percent CO₂ atmosphere in aqueous solution (3 molar, 31 wt. pct. MAMP, 30° C.) is depicted in FIG. 2, showing that short reaction time results in diminished CO₂ absorption according to the reaction represented with MAMP as:

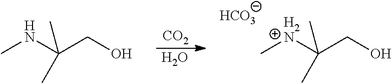

Contact times less than ten minutes, preferably less than one minute and more preferably less than 10 seconds are favored.

In aqueous solution or in non-aqueous solutions containing adventitious water, the reaction with CO₂ to form the bicarbonate may proceed by the mechanism outlined above but in organic solvents in the absence of water sterically hindered MAMP and its derivatives are unlikely to react with CO₂ to form a stable reaction product, while H₂S which does not require H₂O to react with amines will do so, to favor H₂S selectivity further in the presence of CO₂. Suitable non-aqueous solvents include toluene, sulfolane (tetramethylene sulfone) and dimethylsulfoxide (DMSO), acetonitrile, dimethylformamide (DMF), N-methylpyrrolidone (NMP), tetrahydrofuran (THF), ketones such as methyl ethyl ketone (MEK), esters such as ethyl acetate and amyl acetate, and halocarbons such as 1,2-dichlororobenzene (ODCB). Combinations of non-aqueous solvents may be used.

Alternatively, the hindered amine absorbent can be grafted on the surface of meso- or microporous solids or impregnated into their structure for efficient H₂S chemisorption. It has been experimentally proven that grafted amines form carbamate species with CO₂ and do not form (bi)carbonates even when wet gas is used. MAMP and the present structurally related species, however, do not form a carbamate with CO₂ due to their high steric hindrance factors; they react preferably with H₂S so that H₂S/CO₂ selectivity can be very high when grafted onto the porous substrates or impregnated into them. This makes grafted structures using the present hindered amines ideal for CO₂/H₂S separation from both dry and wet gas.

### Hindered Amine Absorbent

Certain members of the present class of hindered amines have been mentioned in the literature. MAMP, EAMP (2-N(ethylamino)-propanol), IPAE (2-(isopropylamino)-2-methyl-ethanol), IBAE (2-(isobutylamino)-ethanol, SBAE (2-(sec-butylamino)-ethanol) and IPDEA (2-(isopropylamino) ethanol) have been described by Chowdhury et al in “Synthesis and selection of hindered new amine absorbents for CO₂ capture’, Energy Procedia 4 (2011) 201-208. The 2-alkyl-2-(aminoalkyl)-alkanols may be synthesized by the ring opening under alkaline conditions of the corresponding tetraalkyl-4,5-dihydrooxazol-3-ium halides. The hydrolysis to an initial ester derivative is reported to be practically instantaneous with extended alkaline hydrolysis leading to the corresponding alkanol. See Allen et al, Hydrolysis of N-Methyl-2,4,4-substituted Δ²-Oxazolinium Iodides, J. Organic Chemistry, 28, 2759 (1963). The symmetrical ether compounds may be made by the Williamson synthesis using the alkanol and the corresponding halide. Asymmetrical ethers may be made using a different halide.

### Process Configuration and Operation

### Liquid Phase Operation

Using the hindered amines in solution, the gas separation can be carried out in the conventional manner where the separation is based on the equilibrium between the gas mixture and a solution of the amine absorbent, normally an aqueous solution. This solution circulates in a continuous closed cycle circulating between an absorption zone and a regeneration zone with both zones conventionally in the form of columns or towers. In the absorption zone, the incoming gas stream is normally passed in a tower in countercurrent to a descending stream of liquid absorbent solution at a relatively low temperature, e.g. 30 to 60° C. The solution containing the separated contaminant then passes to a regeneration tower while the purified gas stream with a reduced concentration of the contaminant, e.g. H₂S, passes out of the top of the absorption tower. In the regeneration tower, the absorbent solution is regenerated by separating the absorbed contaminant by a change in conditions under which desorption is favored, typically by change in temperature or pressure or a combination. Stripping with a hot gas, e.g., steam may be used to raise temperature and decrease partial pressure of the contaminant to favor desorption. The regenerated solution may then be recirculated to the absorption tower after cooling if necessary. The desorbed contaminant may be passed to storage, disposal or utilization.

Operation with the amine absorbent in the liquid phase with non-aqueous solutions and with water present in the gas stream may be conducted in the same manner as outlined above with absorption taking place in one tower or column and regeneration of the absorbent solution in another. During the sorption step, the kinetics favoring H₂S absorption are exploited by limiting mass transfer and using short contact times so that the incoming gas mixture does not remain in contact with the absorbent for the CO₂ to substantially displace the sorbed H₂S.

The sorption solution may include a variety of additives typically employed in selective gas removal processes, e.g., antifoaming agents, anti-oxidants, corrosion inhibitors. The amount of these additives will typically be in the range that they are effective.

The concentration of the amino compound in the selected solvent can vary over a wide range. Amine concentrations may typically range from 5 or 10 weight percent to about 70 weight percent, more usually in the range of 10 to 50 weight percent. Mixtures of amines can be used in comparable total concentrations. The amine concentration may be optimized for specific amine/solvent mixtures in order to achieve the maximum total absorbed H₂S concentration, which typically is achieved at the highest amine concentration although a number of counter-balancing factors force the optimum to lower amine concentrations. Among these are limitations imposed by solution viscosity, amine and/or amine-H₂S product solubilities, and solution corrosivity. In addition, as the amine concentration affects the nature of the amine-H₂S product formed, the amine concentration also directly affects the required regeneration energy for a specific amine/solvent mixture. Therefore, the optimal amine concentration is selected to balance the maximum total absorbed H₂S concentration and the lowest required regeneration energy, contingent upon the viscosity, solubility and corrosivity limitations described above; this concentration is likely to vary for individual amine/solvent combinations and is therefore to be selected on an empirical basis which also factors in the gas feed rate relative to the rate of sorbent circulation in the unit. The temperature and pKa of the amino compound also play into this equation.

The formation of precipitates is regarded as generally undesirable since, if precipitates are formed, the concentration of the active amine sorbent decreases and the amount of amine available for H₂S capture, decreases accordingly. The formation of sulfide precipitates may, be exploited by separation of the solid or slurry of the solid, e.g., by hydrocyclone or centrifuge, followed by desorption of the H₂S from the solid by heating. This enables the absorbent amine to be regenerated with lower energy requirements since much less solvent needs to be stripped, heated or vaporized.

### Sorption

For absorption, the temperature is typically in the range of from about 25° C. to about 90° C., preferably from about 20° C. to about 75° C.; the stability of the H₂S/amine species generally decreases with increasing temperature. In most cases, however, a maximum temperature for the sorption will be 75° C. and if operation is feasible at a lower temperature, e.g., with a chilled incoming natural gas or refinery process stream, resort may be advantageously made to lower temperatures at this point in the cycle. Temperatures below 50° C. are likely to be favored for optimal sorption.

The pressure is typically in the range of from about 0.05 bar to about 20 bar (gauge), preferably from about 0.1 bar to about 10 bar (gauge). The partial pressures of hydrogen sulfide and carbon dioxide in the gas mixture will vary according to the gas composition and the pressure of operation but typically will be from about 0.1 to about 20 bar. abs., preferably from about 0.1 to about 10 bar (abs). The gas mixture can be contacted counter currently or co-currently with the absorbent material at a typical gas hourly space velocity (GHSV) of from about 50 (S.T.P.)/hour to about 50,000 (S.T.P.)/hour with the higher velocities favored with aqueous solutions as noted above to disfavor displacement of sorbed H₂S by CO₂ with linger contact times.

### Desorption

The H₂S can be desorbed from the absorbent material by conventional methods. One possibility is to desorb the carbon dioxide by means of stripping with an inert (non-reactive) gas stream such as nitrogen in the regeneration tower. The reduction in the H₂S partial pressure which occurs on stripping promotes desorption of the H₂S and when this expedient is used, there is no requirement for a significant pressure reduction although the pressure may be reduced for optimal stripping, suitably to the levels used in pressure swing operation.

When carrying out the desorption by inert gas sparging or pressure swing operation, the temperature may be maintained at a value at or close to that used in the sorption step. Desorption, will however, be favored by an increase in temperature, either with or without stripping or a decrease in pressure.

There are potential advantages in the regeneration of H₂S-rich amine streams in non-aqueous systems. In the non-aqueous environment, stripping can be feasible with or without purge gas at relatively lower temperatures. The possibility of desorption at lower temperatures offers the potential for isothermal or near isothermal stripping using a purge gas at a temperature the same as or not much higher than the sorption temperature, for example, at a temperature not more than 30° C. higher than the sorption temperature; in favorable cases, it may be possible to attain a sorption/desorption temperature differential of no more than 20° C. When these factors are taken into consideration the temperature selected for the desorption will typically be in the range of from about 70 to about 120° C., preferably from about 70 to about 100° C., and more preferably no greater than about 90° C.

In non-aqueous systems with water present in the stream to be processed, regeneration may need to be performed at a temperature sufficient to remove the water and prevent build-up in the scrubbing loop. In such a situation, the H₂S may be removed at pressures below atmospheric pressure, but above 100° C. For example, the regeneration temperature may be around 90° C., but to remove any water in the sorbent, temperatures in the range of 100 to 120° C. may be required.

For regeneration in non-aqueous systems, stripping with an inert (non-reactive) gas such as nitrogen or a natural gas stream is preferred. Staged heat exchanger systems with intermediate knock out drums in which H₂S/water is removed as a pressurized gas stream may be used as one alternative.

### Solid Phase Operation

Given the preferential selectivity achieved with short contact times, the present hindered amine absorbents may advantageously be operated in the kinetic separation mode using the amines as adsorbents in a thin layer on a solid support. Kinetically based separation processes may be operated, as noted in US 2008/0282884, as pressure swing adsorption (PDA), temperature swing adsorption (TSA), partial pressure swing or displacement purge adsorption (PPSA) or as hybrid processes, as noted in U.S. Pat. No. 7,645,324 (Rode/Xebec). These swing adsorption processes can be conducted with rapid cycles, in which case they are referred to as rapid cycle thermal swing adsorption (RCTSA), rapid cycle pressure swing adsorption (RCPSA), and rapid cycle partial pressure swing or displacement purge adsorption (RCPPSA) technologies, with the term “swing adsorption” taken to include all of these processes and combinations of them.

In the kinetically-controlled PSA processes, the adsorption and desorption are more typically caused by cyclic pressure variation, whereas in the case of TSA, PPSA and hybrid processes, adsorption and desorption may be caused by cyclic variations in temperature, partial pressure, or combinations of pressure, temperature and partial pressure, respectively. In the exemplary case of PSA, kinetic-controlled selectivity may be determined primarily by micropore mass transfer resistance (e.g. diffusion within adsorbent particles or crystals) and/or by surface resistance (e.g. narrowed micropore entrances). For successful operation of the process, a relatively and usefully large working uptake (e.g. the amount adsorbed and desorbed during each cycle) of the first component and a relatively small working uptake of the second component may preferably be achieved. Hence, the kinetic-controlled PSA process requires operation at a suitable cyclic frequency, balancing the avoidance of excessively high cycle frequency where the first component cannot achieve a useful working uptake with excessively low frequency where both components approach equilibrium adsorption values.

The faster the beds perform the steps required to complete a cycle, the smaller the beds can be when used to process a given hourly feed gas flow. Several other approaches to reducing cycle time in PSA processes have emerged which use rotary valve technologies as disclosed in U.S. Pat. Nos. 4,801,308; 4,816,121; 4,968,329; 5,082,473; 5,256,172; 6,051,050; 6,063,161; 6,406,523; 6,629,525; 6,651,658 and 6,691,702. A parallel channel (or parallel passage) contactor with a structured adsorbent may be used to allow for efficient mass transfer in these rapid cycle pressure swing adsorption processes. Approaches to constructing parallel passage contactors with structured adsorbents have been disclosed in US20060169142 A1, US20060048648 A1, WO2006074343 A2, WO2006017940 A1, WO2005070518 A1, and WO2005032694 A1.

The use of the hindered amine in the form of a film of controlled thickness on the surface of a core which has a low permeability has significant advantages in rapid cycle processes with cycle durations typically less than one minute and often rather less. By using a thin film, heat accumulation and retention is reduced so that exotherms and hot spots in the absorbent bed are minimized and the need for heat sinks such as the aluminum spheres common in conventional beds can be eliminated by suitable choice of the core material; rapid cycling is facilitated by the fast release of heat from the surface coating and the relatively thin layer proximate the surface of the core. A further advantage is secured by the use of low permeability (substantially non-porous) cores which is that largely inhibit entry of the gas into the interior pore structure of the core material is largely inhibited and so that mass and heat transfer takes place more readily in the thin surface layer; and retention of gas within the pore structure is minimized.

Selectivity for H₂S sorption will be diminished to a certain extent not only by the relative adsorption characteristics of the selected adsorbent material but also by the physical sorption of CO₂ in both liquid and solid systems which becomes more perceivable at higher pressures: the lower the partial pressures of both H₂S and CO₂, the greater will be the selectivity for H₂S. To operate using the amino compound in the solid phase as an adsorbent, the compound is physically or chemically taken up onto on a solid support or carrier material of high surface area. If the basic compound is a solid, it may be dissolved to form a solution which can then be used to impregnate or react with the support material or deposited on it in the form of a thin, wash coat layer of discrete sorbent particles or agglomerates of sorbent particles adhered to the surface of the support. Discrete particles or agglomerates may be adhered effectively by physical interaction at the surface of the support. Porous support materials are generally preferred in view of the greater surface area which they present for the sorption reaction but finely-divided non-porous solids with a sufficiently large surface area may also be used. In either case, the sorbent compound(s) may be physisorbed onto the support material or held onto the surface of the support in the form of a thin, adherent surface layer firmly bonded to the support by physical interaction or alternatively grafted onto the support by chemical reaction.

Porous support materials are frequently used for the catalysts in catalytic processes such as hydrogenation, hydrotreating, hydrodewaxing etc and similar materials may be used for the present sorbents. Common support materials include carbon (activated charcoal) as well as porous solid oxides of metals and metalloids and mixed oxides, including alumina, silica, silica-alumina, magnesia and zeolites. Porous solid polymeric materials are also suitable provided that they are resistant to the environment in which the sorption reaction is conducted. As the components of the gas stream have relatively small molecular dimensions, the minimum pore size of the support is not in itself a severely limiting factor but when the basic nitrogenous compound is impregnated, the entrances to the pore systems of small and intermediate pore size zeolites such as zeolite 4A, erionite, ZSM-5 and ZSM-11 may become occluded by the bulky amine component and for this reason, the smaller pore materials are not preferred, especially with the bases of relatively larger molecular dimensions. Large pore size zeolites with 12-membered ring systems such as ZSM-4, faujasites such as zeolite X and the variants of zeolite Y including Y, REY and USY, may, however, be suitable depending on the dimensions of the basic nitrogenous compound. Amorphous porous solids with a range of different pore sizes are likely to be suitable since at least some of the pores will have openings large enough to accept the basic component and then to leave sufficient access to the components of the gas stream. Supports containing highly acidic reaction sites as with the more highly active zeolites are more likely to be more susceptible to fouling reactions upon reaction with the amino compound and less acidic or non-acidic species are therefore preferred.

A preferred class of solid oxide support is constituted by the mesoporous and macroporous silica materials such as the silica compounds of the M41S series, including MCM-41 (hexagonal) and MCM-48 (cubic) and other mesoporous materials such as SBA-1, SBA-2, SBA-3 and SBA-15 as well as the KIT series of mesoporous materials such as KIT-1. Macroporous silicas and other oxide supports such as the commercial macroporous silicas available as Davisil products are also suitable, e.g. Davisil 634 (6 nm pore size, 480 m²/g pore volume), Davisil 635 (6 nm, 480 m²/g) and Davisil 644 (15 nm, 300 m²/g). According to the IUPAC definition, mesoporous materials are those having a pore size of 2 to 50 nm and the macroporous, those having a pore size of over 50 nm. According to the IUPAC, a mesoporous material can be disordered or ordered in a mesostructure. The preferred mesoporous and macroporous support materials are characterized by a BET surface area of at least 300 and preferably at least 500 m²/g prior to treatment with the base compound. The M41S materials and their synthesis are described in a number of patents of Mobil Oil Corporation including U.S. Pat. No. 5,102,643; 5,057,296; 5,098,684 and 5,108,725, to which reference is made for a description of them. They are also described in the literature in “The Discovery of ExxonMobil's M41S Family of Mesoporous Molecular Sieves”, Kresge et al, Studies in Surface Science and Catalysis, 148, Ed. Terasaki, Elsevier bV 2004. SBA-15 is described in “Triblock Copolymer Syntheses of Mesoporous Silica with Periodic 50 to 300 Angstrom Pores”, Dongyuan Zhao, et al. (1998). Science 279 (279). KIT-1 is described in U.S. Pat. No. 5,958,368 and other members of the KIT series are known, for example KIT-5 and KIT-6 (see, e.g. KIT-6 Nanoscale Res Lett. 2009 November; 4(11): 1303-1308). The H₂S/CO₂ selectivity of the material can be adjusted by the judicious choice of the porous support structure, affording a significant potential for tailoring the selectivity of the adsorbent.

The basic nitrogenous compound may simply be physically sorbed on the support material e.g. by impregnation or bonded with or grafted onto it by chemical reaction with the base itself or a precursor or derivative in which a substituent group provides the site for reaction with the support material in order to anchor the sorbent species onto the support. Chemical bonding is not, however, required for an effective solid phase sorbent material; effective sorbents may be formed by physical interaction when the sorbent is itself strongly adsorbed by the support material. Chemical bonding may be effected by the use of support materials which contain reactive surface groups such as the silanol groups found on zeolites and the M41S silica oxides which are capable or reacting with a silylated derivative of the selected amine compound. The high concentrations of surface silanol groups (SiOH), on silica and ordered siliceous materials such as the zeolites and mesoporous materials, e.g. MCM-41, MCM-48, SBA-15 and related structures, render these materials amenable to surface modification by grafting of the functional amine onto the pore walls of the siliceous support via a reaction between the surface silanol groups of the support and the grafting material according to the conventional technique; see, for example, Huang et al., Ind. Eng. Chem. Res., 2003, 42 (12), 2427-2433. For grafting purposes, the amine molecule could have methoxy- or ethoxy-silanol groups, e.g. as in 2-(N-methylamino)-2-methylpropan-1-yl-trimethoxysilane or 2-(N-methylamino)-2-methylpropan-1-yl-triethoxysilane when the preferred MAMP is to be grafted onto the support; the alkoxy groups will react with the —OH groups on the surface of the siliceous material with the release of methanol or ethanol to yield a final structure on the surface of the support represented (with MAMP as the amine) as:

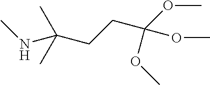

An alternative method of fixing more volatile adsorbing species on the support is by first impregnating the species into the pores of the support and then cross-linking them in place through a reaction which does not involve the basic nitrogenous groups responsible for the sorption reaction in order to render the sorbing species non-volatile under the selected sorption conditions. Grafting or bonding methods are known in the technical literature. The molecular dimensions of the base sorbent should be selected in accordance with the pore dimensions of the support material since bulky bases or their precursors or derivatives may not be capable of entering pores of limited dimensions. A suitable match of base and support may be determined if necessary by empirical means.

Solid phase sorbents will normally be operated in fixed beds contained in a suitable vessel and operated in the conventional cyclic manner with two or more beds in a unit with each bed switched between sorption and desorption and, optionally, purging prior to re-entry into the sorption portion of the cycle. Purging may be carried out with a steam of the purified gas mixture, i.e. a stream of the gas from which the H₂S has been removed in the sorption process. If operated in temperature swing mode, a cooling step will intervene at some point between desorption and re-entry to sorption; this step will usually constitute a purge after desorption is completed. Alternatively, moving bed systems may be used with particulated solid sorbents or fluidized bed systems with finely-divided solids, e.g. with a particle size up to about 100μ with the sorbent treated functionally as a liquid circulated between a sorption zone and a desorption/regeneration zone in a manner similar to a fluid catalytic cracking unit; rotating wheel beds are notably useful in rapid cycle sorption systems. All these systems may be operated in their conventional manner when using the present sorbents. Fixed bed systems may be operated with beds of solid porous particulate sorbents, porous monoliths or with layers of the sorbent on a porous or non-porous support For rapid cycle operation it may be possible to operate the separation using thin, adherent wash coats of the sorbent on plate type support elements.

### Experimental Procedure for Synthesis of 2-methyl-2-(methylamino)propan-1-ol (MAMP)

Iodomethane (0.02 mol) was added slowly to 2,4,4-trimethyl-4,5-dihydrooxazole (2 g, 0.015 mol) in THF (−5 mL) and stirred for 36 h at 20-25° C. with cooling on cold water. The white precipitate was recrystallized by adding hexanes (−10 mL) to the reaction mixture. Filtration, washing with diethyl ether and drying under vacuum gave 2,3,4,4-tetramethyl-4,5-dihydrooxazol-3-ium iodide (3.3 g, 0.013 mol, 88%) as white microcrystals (mp 140.0-141° C.).

The 2,3,4,4-tetramethyl-4,5-dihydro-oxazol-3-ium iodide was added to an aqueous sodium hydroxide solution (35%, 15 ml). The mixture was stirred on a steam bath for 1.5 h, cooled to 20-25° C. and extracted with diethyl ether (4×15 mL). The organic portions were combined, dried over anhydrous MgSO₄, filtered and concentrated on a rotary evaporator to give 2-methyl-2-(methylamino)propan-1-ol (1.1 g, 82%) as a sticky solid.

### General Procedure for Acid Gas Uptake and Desorption

The experimental setup for monitoring of amine acid gas uptake by was built inside a wide bore 400 MHz Bruker Avance™ nuclear magnetic resonance (NMR) spectrometer equipped with variable temperature capabilities. A 10 mm NMR tube containing a solution of the desired amine, typically in H₂O, D₂O or d₆-dimethylsulfoxide, was treated with an acid gas, e.g., CO₂ at ambient pressure and a flow rate of 10 cc/minute inside the instrument while recording quantitative ¹H and ¹³C{¹H} NMR spectra. Internal solution temperature and pH were simultaneously measured. Desorption/regeneration experiments were performed by changing the feed gas to N₂ and increasing the solution temperature if needed.

¹³C and ¹H spectra taken before, during, and after the absorption/desorption sequence(s) gave quantitative information about the starting solution, reaction kinetics, and intermediate/final sorption products. The reaction products seen in ¹³C and ¹H NMR spectra were identified and quantified by integration of the ¹³C NMR carbonyl resonance(s) at 165-155 ppm (representing sorbed CO₂) versus resonances representing the amine —OCH₂CH₂N— and (if present)-NCH₃ groups. When desired, samples were transferred into a 5 mm NMR tube for more accurate ex-situ 1D and 2D NMR analysis on a Bruker Avance III™ narrow bore 400 MHz spectrometer.

For monitoring non-aqueous reactions, several anhydrous molecules were used as solvents for the amine (d₆-DMSO, d₈-toluene, chloroform, and sulfolane). In order to eliminate solvent influence completely, several amines were treated with CO₂ without any solvent. Results of the latter experiments qualitatively showed the presence of similar reaction products as seen in the solvents listed above. It was observed that the protons of the ammonium carbamate counterion (—NH₃⁺) and carbamic acid (—NH—COOH) are in fast exchange resulting in a single resonance peak above 8 ppm. At the same time, the —NH—COO⁻ and —NH—COOH protons of the carbamate and carbamic acid species, respectively, also are seen as a single peak around 6 ppm. The relative concentration of carbamic acid and carbamate in the solution was verified based on quantitative analysis of these two peaks.

Further details are given below.

### Example 1

### CO₂ Reaction Mechanism with MAMP

The secondary severely hindered amine, 2-methyl-2-(methylamino)propan-1-ol (MAMP), was studied as an example of compound with slow CO2 reaction rates in aqueous solution. Severely hindered amines such as MAMP can be used for kinetic separation of CO₂/H₂S based on fast reaction rates with H₂S and slow reaction rates with CO₂.

FIG. 1 shows the ¹³C NMR spectra of 2-methyl-2-(methylamino)propan-1-ol as a 3 molar solution in H₂O prior and after addition of CO₂ at 30° C. MAMP purity is confirmed with four 13C resonances at 67.29, 53.47, 27.43, and 22.30 ppm, which indicate 5 carbons of MAMP (peak at 22.30 ppm reflect two methyl groups on tertiary carbon).

As CO₂ was introduced into the amine solution at 30° C., one peak appeared in the carbonyl region at ˜167 ppm corresponding to initial formation of carbonate species; with increasing reaction time (from bottom to top of graph), this gradually shifted to 161.2 ppm at saturation as shown in FIG. 2 (top). This peak was assigned as bicarbonate/carbonate in rapid equilibrium. The amine backbone carbons showed sensitivity to the formation of the (bi)carbonate, shifting slightly upfield (consistent with protonation to an ammonium species) while maintaining a simple four-peak structure indicating clean formation of only one product type (FIG. 2, bottom). The final assigned ¹³C NMR spectrum of the secondary ammonium (bi)carbonate product is shown in FIG. 1.

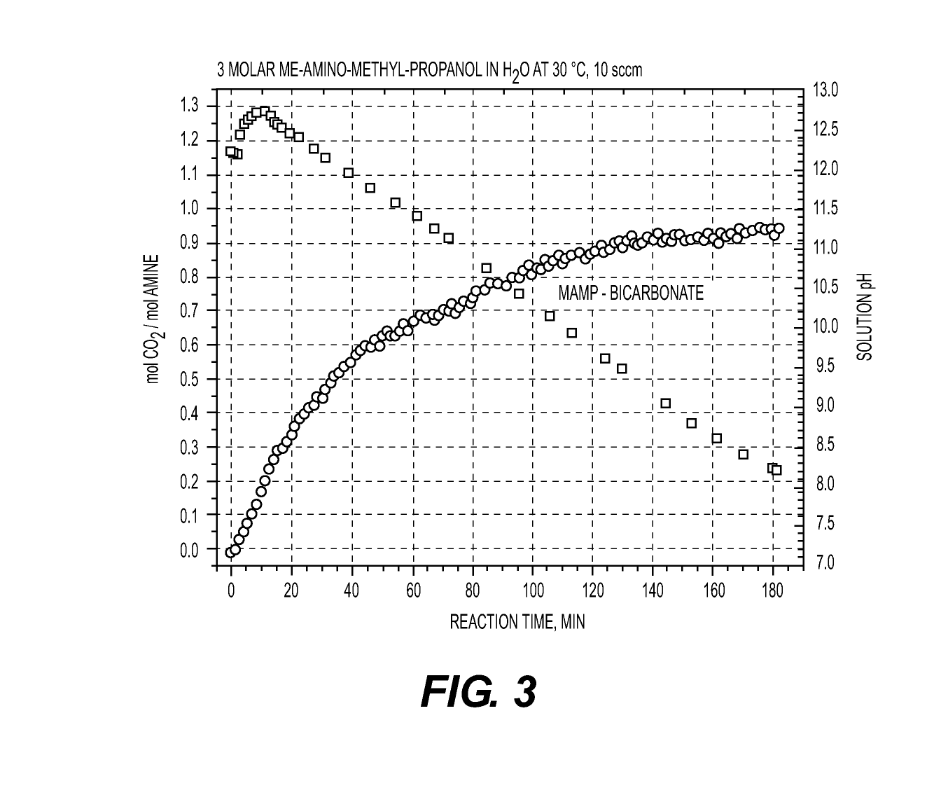

FIG. 3 shows a graph of the ratio of captured CO₂ per amine group (as quantified by the integral of the bicarbonate/carbonate ¹³C NMR resonance) over time as CO₂ was bubbled through the system. After approximately 3 hours of bubbling, the maximum achieved amount of CO₂ reacted as (bi)carbonate was reached and was 0.92 moles of CO₂ per amine group. For a system in which 100% of the captured CO₂ is present in bicarbonate form, the theoretical maximum uptake is 1.0 mole of CO₂ per amine group. The fact that the amount of CO₂ reacted is near this limit also implies that the product is present mainly in bicarbonate, rather than carbonate (theoretical uptake limit=0.5 mole of CO₂ per amine group) form. The apparent 92% loading may either imply that 8% of the amines remain unreacted, or that 16% of the amines are ammonium groups associate with divalent carbonate rather than monovalent bicarbonate species.

Unlike regular nucleophilic primary and secondary amines such as monoethanolamine (MEA) and N-methylaminoethanol (MAE), hindered secondary amine MAMP does not form a carbamate reaction product with CO₂ and directly forms bicarbonate/carbonate species. This reaction mechanism is characterized by a very long reaction constant and is known for tertiary amines such as dimethylaminoethanol (DMAE) or triethanolamine (TEA). The reaction constant for direct bicarbonate formation of tertiary or severely hindered amines with CO₂ is 10-100 times lower.

### Example 2

### CO₂ Reaction Mechanism with MEA (Comparative)

The primary amine, mono-ethanol-amine (MEA), was studied as an example of a compound with fast CO₂ reaction rates in aqueous solution. Such compounds will unlikely be suitable for kinetically-based separation of CO₂/H₂S as the reaction rates are similar.

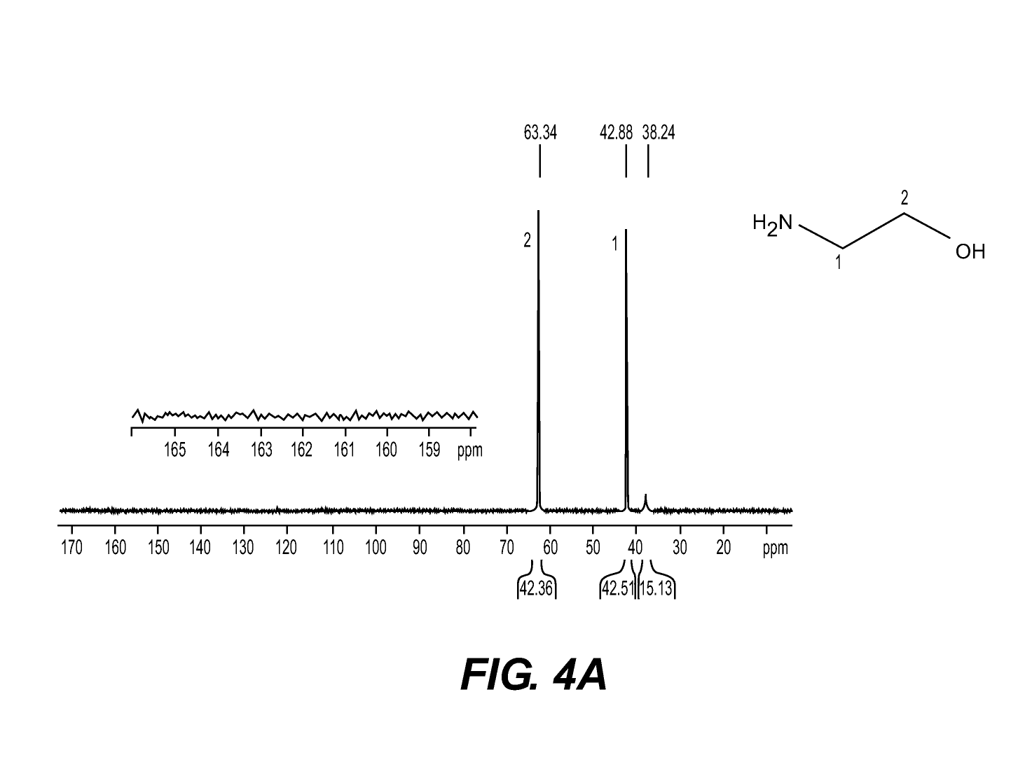

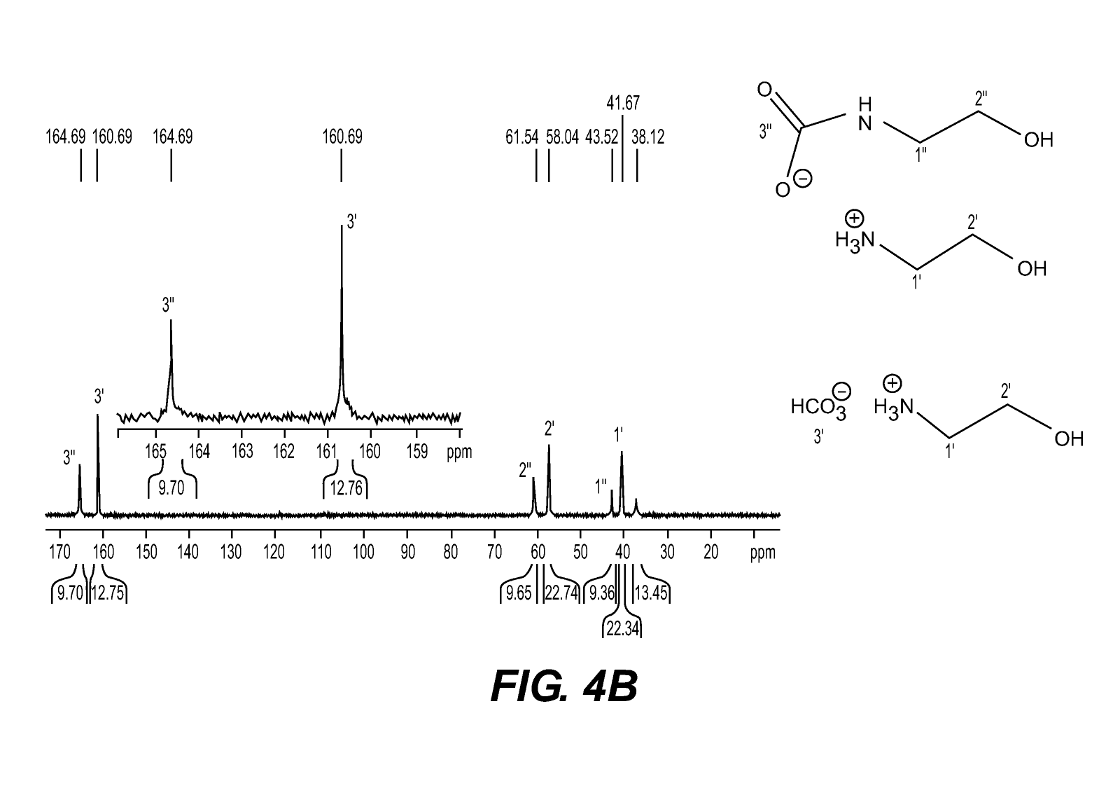

FIG. 4 shows the ¹³C NMR spectra of mono-ethanol-amine as a 3 molar solution in H₂O prior and after addition of CO₂ at 30° C. MEA purity is confirmed with two ¹³C resonances at 63.34 and 42.88 ppm, which indicate 2 carbons of MEA.

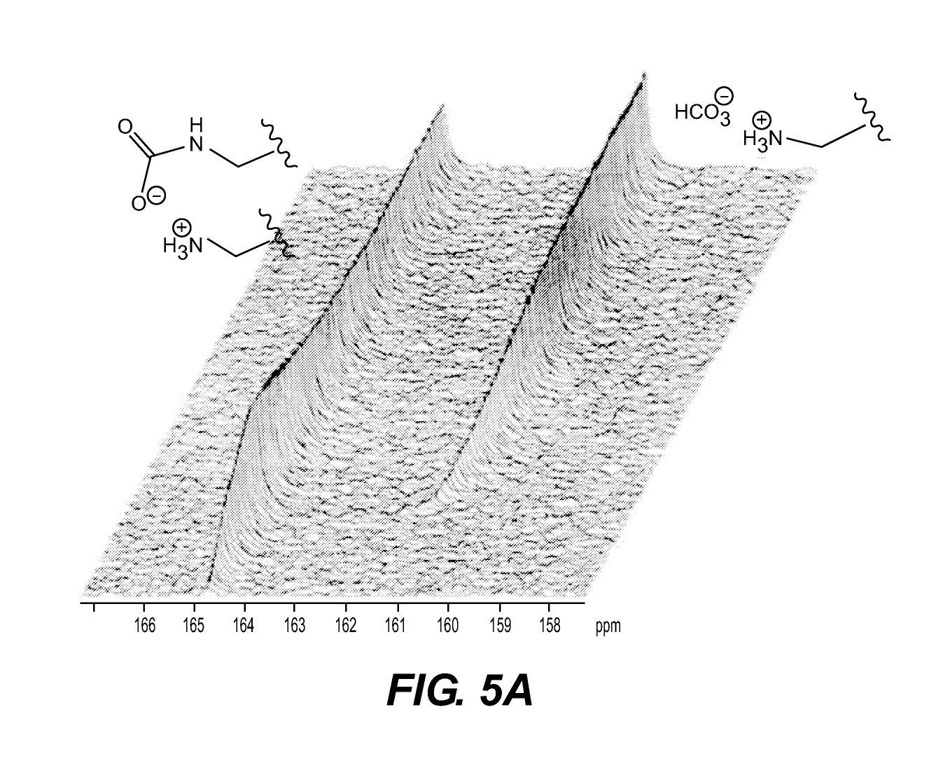

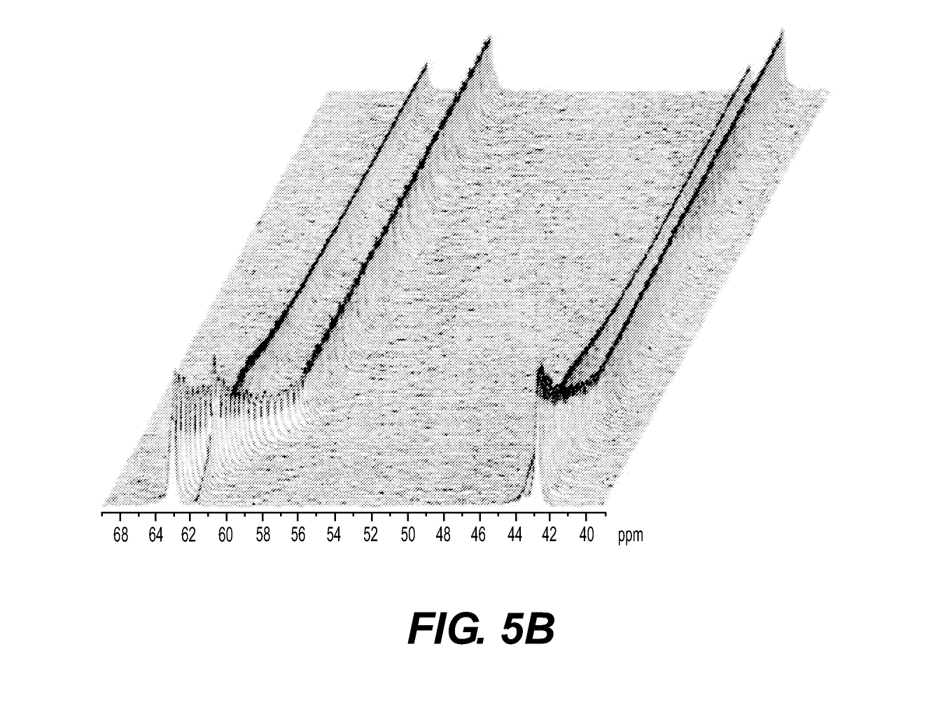

As CO₂ was introduced into the amine solution at 30° C., one peak appeared in the carbonyl region at ˜165 ppm that corresponds to initial formation of carbamate species (FIG. 5, top). With increasing reaction time (increases from bottom to top of graph) this reaction product continued to grow and reached a maximum at CO₂ loading of approximately 0.5 CO₂ groups per amine, at which point it began to decline as a second singlet resonance appeared at 160.8 ppm (bicarbonate) and grew larger (FIG. 5, top). The backbone carbons of the amine molecule show related shifting and splitting in the ¹³C NMR spectrum, as shown in FIG. 5, bottom. Both peaks shift upfield, as was observed for the hindered amine, and also split into two peak clusters: this mirrors the carbamate C═O peak, and singlets representing the —CH₂NH₃⁺ sites associated with the (bi)carbonates. The final assigned ¹³C NMR spectrum of the carbamate and ammonium (bi)carbonate product is shown in FIG. 4, bottom.

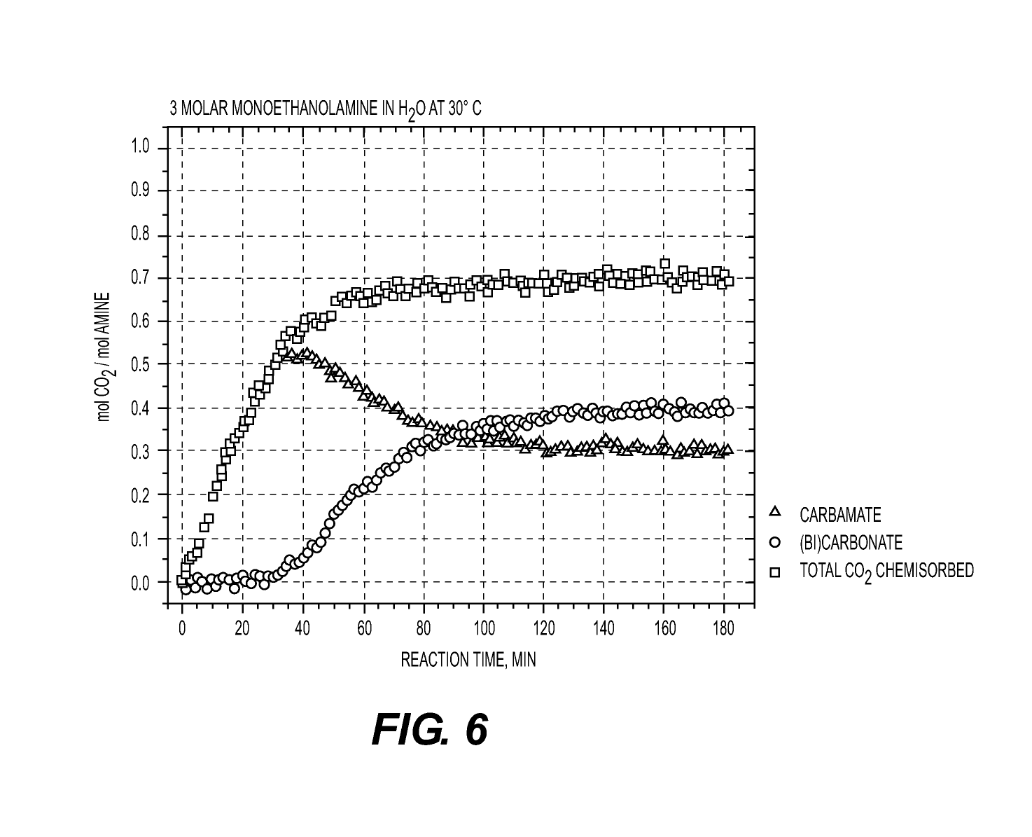

FIG. 6 shows a graph of the ratio of captured CO₂ per amine group (as quantified by the integral of the bicarbonate/carbonate ¹³C NMR resonance) over time as CO₂ was bubbled through the MEA system. After approximately 40 minutes of bubbling, all amines in solution reacted with CO₂ and formed carbamate species. This caused significant change of solution pH to ˜8 (not shown here). Then carbamate species were slowly transformed into bicarbonate.

With MAMP, the solution was close to saturation after 180 minutes (FIG. 3) which is approximately 5 times longer than saturation of MEA. Zero order reaction rates between CO₂ and various amines were also measured by a stopped flow kinetic technique. For less hindered amines such as 2-amino-2-methyl-propanol (AMP), reaction rate was 90 s⁻¹ which is 15 times slower than MEA (1305 s⁻¹). Reaction rates of severely hindered amines such as MAMP should be even slower; in the range of 10-20 s⁻¹, typical for direct bicarbonate formation with tertiary amines.

### Example 3

The following hindered amines were tested for their absorption characteristics on acidic gas:

| | |
|---|---|
| MAMP | 2-N-methylamino-2-methyl-propan-1-ol |
| EETB | Ethoxyethanol-t-butylamine |
| MEEETB | Methoxyethoxyethoxyethanol-tert-butylamine or |
| | t-butylamino-ethoxyethoxyethyl methyl ether) |
| DEGTB/ | Diethylene glycol-t-butylamine mixture with bis- |
| DEG(TB)2 blend | DEGTB (bis-(t-butylamino)-DEG) |

The study was carried out by bubbling a gas mixture containing 10% v/v CO₂, 1% H₂S, balance N₂, through a stirred 2.17 molar aqueous amine solution at 40° C. (absorbent and gas), 138 kPag (20 psig) at a gas flow rate of 600 mL/min. The gas is introduced into the solvent solution down a dip tube with the outlet submerged just below (8 mm) the surface of the solvent. These parameters were found to provide stable and repeatable data for the test solutions. The test gas is water saturated before entering the test cell. A variable speed paddle mixer circulates solvent past the dip tube at a controlled rate. The cell was run at atmospheric pressure. Gas venting from the cell is passed through a collection pot where it is sampled and analyzed for H₂S and CO₂ concentration. using a GASTEC™ stain tube (colorimetric quantification).

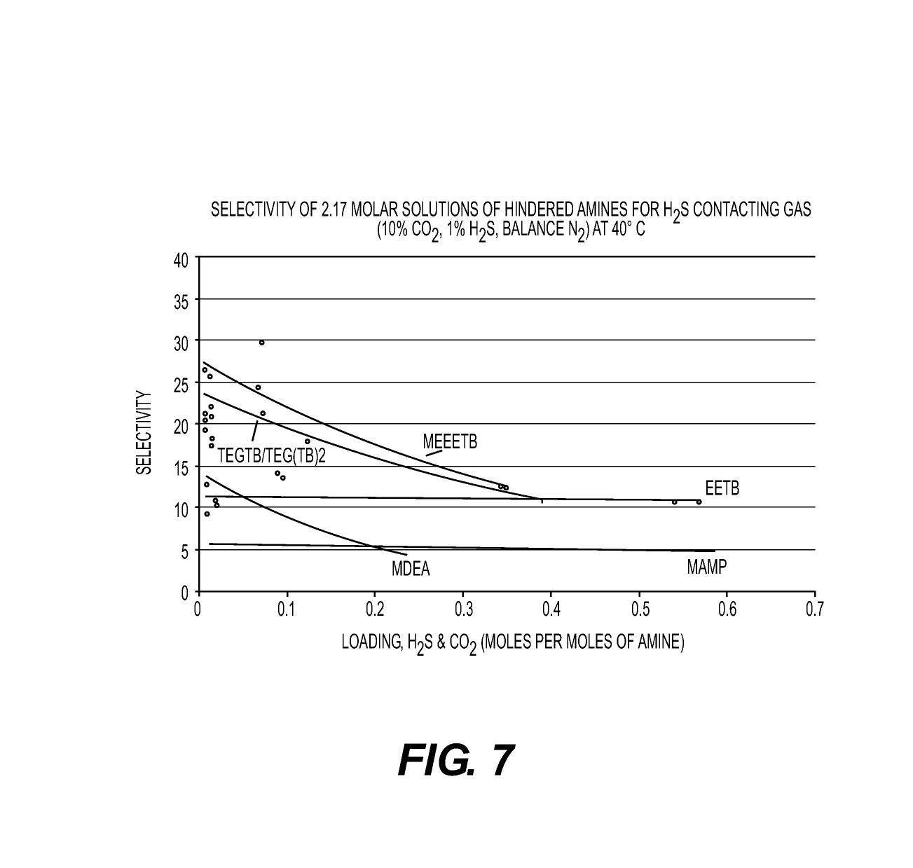

The selectivities of the solutions were calculated as the ratio of H₂S and CO₂ absorbed in the solution to the H₂S and CO₂ in the feed gas (moles/moles). FIG. 7 shows that although the MAMP is not as selective for H2S as the etheramines (EETB, MEEETB and the TEGTB/TEG(TB)₂ mixture, the MAMP maintains a selectivity which is linear with loading over the wide range of gas loadings tested. The selectivity is not as high as that of EETB (ethoxyethanol-t-butylamine) which also exhibits linear selectivity with loading, the lower molecular weight of MAMP provides and advantage in large scale us in view of its lower molecular weight relative to the etheramines. Linearity is an advantageous characteristic since the flow rates of the gas and the circulating absorbent liquid in the unit need not be maintained within a narrow range, so permitting rate variations to be more readily accommodated. In addition, the selectivity of MAMP is greater than that of the commercial absorbent, MDEA, over an extended range of loadings

1. A process for the selective separation of H₂S from an acid gas mixture containing H₂S and CO₂ which comprises contacting the gas mixture with a compound of the formula: 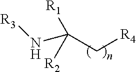
where
R³ is a C₁-C₄ alkyl group,
R¹ and R² are each a C₁-C₄ alkyl group,
R⁴ is OH or OR⁵,
R⁵ is —CH²—CR¹R²—NHR³ and
n is an integer from 1 to 4.

2. A process according to claim 1 in which R³ is CH₃.

3. A process according to claim 1 in which R¹ and R² are each CH₃ or C₂H₅

4. A process according to claim 1 in which at least one of R₁, R₂ and R₃ is a tertiary alkyl group.

5. A process according to claim 1 in which R₃ is a tertiary alkyl group.

6. A process according to claim 1 in which R₃ is tertiary butyl.

7. A process according to claim 1 in which R⁴ is OH

8. A process according to claim 1 in which n is an integer from 1 to 4, preferably 1-3.

9. A process according to claim 1 in which R³ is CH₃, R¹ and R² are CH₃ or C₂H₅, R⁴ is OH and n is 1.

10. A process according to claim 1 in which the compound is 2-(N-methylamino)-2-methyl propan-1-ol.

11. A process according to claim 1 in which the acid gas mixture is contacted with an aqueous solution of the compound.

12. A process according to claim 1 in which the acid gas mixture is contacted with anon-aqueous solution of the compound.

13. A process according to claim 1 in which the acid gas mixture is contacted with a solid grafted or impregnated with the compound.

14. A process according to claim 11 in which the acid gas mixture is contacted with the compound for a contact time less than 10 minutes

15. A process according to claim 14 in which the acid gas mixture is contacted with the compound for a contact time less than 1 minute

16. A process according to claim 15 in which the acid gas mixture is contacted with the compound for a contact time less than 10 seconds.

17. A process according to claim 16 in which the acid gas mixture is contacted with the compound for a contact time less than 5 seconds.

18. A process according to claim 12 in which the acid gas mixture is contacted with the compound for a contact time less than 1 minute.

19. A process according to claim 18 in which the acid gas mixture is contacted with the compound for a contact time less than 10 seconds.

20. A process according to claim 19 in which the acid gas mixture is contacted with the compound for a contact time less than 5 seconds.
